(19) United States
(12) Patent Application Publication
(10) Pub. No.: US 2015/0180178 A1
(43) Pub. Date: Jun. 25, 2015

(54) Fastener Assembly For Use With Vehicle Article Carrier

(71) Applicant: JAC Products, Inc., Saline, MI (US)

(72) Inventors: Noel v. RANKA, Canton, MI (US); Jeffrey M. AFTANAS, Ortonville, MI (US); Gerard J. KMITA, Allen Park, MI (US)

(21) Appl. No.: 14/571,754

(22) Filed: Dec. 16, 2014

Related U.S. Application Data
(60) Provisional application No. 61/919,401, filed on Dec. 20, 2013.

(51) Int. Cl. H01R 13/66; B60R 9/058

(52) U.S. Cl. CPC H01R 13/66; B60R 9/058

(57) ABSTRACT

An electromechanical connector is disclosed that may include a body portion and a threaded bolt. The body portion is made of an electrically conductive material and includes a flange and a deformable portion configured to bulge outwardly when the body portion is positioned in an opening in a wall-like structure and non-removably coupled, in a rivet-like manner, to the structure. The flange and the deformable portion secure the body portion to the wall-like structure. The body portion has a threaded bore, a first tab extending from a first end of the body portion, and a second tab extending from a second end of the body portion. The first tab, the body portion and the second tab form an electrically conductive path through the connector. The threaded bolt is threadably inserted into the threaded bore of the body portion and secures an independent component to the wall-like structure using the electromechanical connector.

### CROSS REFERENCE TO RELATED APPLICATIONS

The present application claims priority from U.S. provisional patent application Ser. No. 61/919,401, filed Dec. 20, 2013, the entire disclosure of which is hereby incorporated by reference into the present application.

### FIELD

The present disclosure relates to vehicle article carrier systems, and more particularly to a fastener assembly especially well adapted for use with a vehicle article carrier system that enables both physical and electrical connections to be made with the fastener system.

### BACKGROUND

This section provides background information related to the present disclosure which is not necessarily prior art.

Vehicle article carriers are used in a wide variety of applications to transport variously articles above an outer body surface of a vehicle. Typical vehicles, without limitation, are cars, trucks, SUVs, station wagons, minivans, full size vans and pickup trucks. The assignee of the present application, JAC Products, Inc. has been a leader in the design, development and production of a wide variety of vehicle article carriers for use on motor vehicles.

Typically vehicle article carriers employ a pair of side rails that are physically secured by rivet-like fasteners, for example RIVNUT® fastener assemblies, to a vehicle roof. The RIVNUT® fasteners extend through a hole in the vehicle roof and enable a secure physical connection of the side rails to the vehicle body surface. Traditionally, however, if any electrical component is being used on the siderail, for example a light, then a second hole would need to be formed in the vehicle roof to allow an electrical conductor to pass through the roof. Obviously, this is undesirable for several reasons. For one, it requires an additional manufacturing operation to drill or form the additional hole. An additional hole in the roof also increases the chance of water leakage through the hole, and typically would require some additional components, such as a gasket or grommet to help ensure against leakage. These components add additional cost to the overall vehicle article carrier system.

### SUMMARY

In one aspect the present disclosure relates to an electromechanical connector that may include a body portion and a threaded bolt. The body portion may be made of an electrically conductive material and may include a flange and a deformable portion configured to bulge outwardly when the body portion is positioned in an opening in a wall-like structure and non-removably coupled, in a rivet-like manner, to the structure. The flange and the deformable portion operate to secure the body portion to the wall-like structure. The body portion may have a threaded bore, a first tab extending from a first end of the body portion, and a second tab extending from a second end of the body portion. The first tab, the body portion and the second tab may form an electrically conductive path through the connector. Each of the first and second tabs may be configured to receive a conductor. The threaded bolt may be configured to be threadably inserted into the threaded bore of the body portion for securing an independent component to the wall-like structure using the electromechanical connector.

In another aspect the present disclosure relates to an electromechanical connector for use with an article carrier component, where the article carrier component is fixedly secured to a vehicle roof. The electromechanical connector may comprise a body portion made of an electrically conductive material. The body portion may also include a flange and a deformable portion configured to bulge outwardly when the body portion is positioned in an opening in a wall-like structure and non-removably coupled, in a rivet-like manner, to the structure. The flange and the deformable portion may operate to secure the body portion to the wall-like structure. The body portion may have a threaded bore and a first tab extending from a first end of the body portion. The first tab may be configured to receive an electrical conductor. An independent metallic tab element may be included which is adapted to be fixedly secured to the article carrier component. The independent metallic tab element may include a second tab projecting therefrom adapted to receive an electrically conductive component. A threaded bolt may be included which is configured to be threadably inserted into the threaded bore of the body portion for both securing the article carrier component to the vehicle roof, once the body portion is secured in the rivet-like fashion to the vehicle roof, and electrically coupling the independent metallic tab element to the body portion. The body portion, the first tab, the independent metallic tab element and the second tab form an electrically conductive path through the body portion when the independent metallic tab element is secured to the body portion.

In still another aspect the present disclosure relates to an electromechanical connector configured for use with a roof structure of a vehicle. The electromechanical connector may comprise a body portion made of an electrically conductive material. The body portion may include a flange and a deformable portion configured to bulge outwardly when the body portion is positioned in an opening in a wall-like structure and non-removably coupled, in a rivet-like manner, to the structure. The flange and the deformable portion operate to secure the body portion to the wall-like structure. The body portion may have a threaded bore, a first tab extending from a first end of the body portion, and a second tab extending from a second end of the body portion, the second end representing the flange of the body portion, and the second tab forming an integral portion of the flange of the body portion, and the first tab forming an integral portion of the body portion at the first end. The first tab, the body portion, the flange and the second tab form an electrically conductive path through the electromechanical connector. Each of the first and second tabs may be configured to receive a conductor. A threaded bolt may be configured to be threadably inserted into the threaded bore of the body portion for securing an independent component to the wall-like structure using the electromechanical connector.

### DRAWINGS

The drawings described herein are for illustration purposes only and are not intended to limit the scope of the present disclosure in any way.

FIG. 1 shows a perspective view of one embodiment of a vehicle article carrier system in accordance with the present disclosure, with the system being secured to an outer body surface of a passenger motor vehicle;

FIG. 2 is an enlarged perspective view of just one support rail of the system of FIG. 1 secured to the outer body surface of the vehicle;

FIG. 3 is a cross sectional end view of the support rail of FIG. 2 taken along section line 3-3 in FIG. 2, illustrating a light transmitting element that is contained within a channel of the support rail, where the light transmitting element generates a quantity of light to assist in lighting the sides of the vehicle;

FIG. 4 is a perspective view of a portion of the light transmitting element;

FIG. 5 is a perspective view of a portion of the support rail of FIG. 2 taken from underneath the outer body surface of the vehicle, and showing the LED housing and its associated conductors secured within a hole in the outer body vehicle surface;

FIG. 6 is a cross sectional view of a portion of one rear support foot taken in accordance with section line 6-6 in FIG. 2 illustrating the abutting coupling of an input end of the light transmitting element with the LED housing, and further illustrating how the LED housing is retained within the hole in the outer body surface of the vehicle;

FIG. 7 is a perspective view looking down onto the outer body surface of the vehicle without the support rail of FIG. 2 attached, to illustrate the LED housing and the light that is projected upwardly through the hole in the outer body surface;

FIG. 8 is a perspective view of the undersurface of a portion of the rear support foot portion of the support rail of FIG. 2 illustrating how the input end of the light transmitting element is supported in a boss portion within the rear support foot portion;

FIG. 9 is a partial cross sectional view of the rear support foot used to support the support rail of FIG. 2, and how the light transmitting element passes through an opening in surface portion into the boss portion;

FIG. 10 is a side view of a pickup truck incorporating a grab rail, a door handle molding and a step bar that each incorporates the teachings of the present disclosure; and

FIG. 11 is a perspective view of a rear bumper of a sport utility vehicle that incorporates a light transmitting element in the step bumper portion of the rear bumper, in accordance with the teachings of the present disclosure;

FIGS. 12 and 13 illustrate another embodiment of a support rail that includes an integrated solar panel cell, battery and wireless receiver;

FIG. 14 shows an electronic assembly that may be mounted in one of the support feet to assist or enable functions relating to satellite radio, GPS or other wireless signal operations;

FIG. 14A is a perspective view of a cover that may be used to form a hermetically sealed enclosure for the circuit board of FIG. 14;

FIG. 15 illustrates another embodiment of a support rail that includes a pair of rear facing (relative to the vehicle) support feet that each include an integrated light and a reflector;

FIG. 16 illustrates another embodiment of a support rail in which the support rail includes an enlarged, integrated reflector built into its rear support foot;

FIG. 17 illustrates another embodiment of a support rail in which a pair of support feet of the support rail each include a camera 608 that is able to image a predetermined range or swath of area adjacent to the vehicle;

FIG. 18 is a planar view of a vehicle incorporating a pair of the support rails of FIG. 17, with each of the support rails including a camera at each of its support feet, and showing the coverage area provided by the four cameras;

FIG. 19 shows an image that may be transmitted by one of the cameras of FIG. 18 to a user's cell phone for display;

FIG. 20 shows a view from a different one of the cameras on the support rails of FIG. 18;

FIG. 21 shows yet another view from a different one of the cameras of the support rails of FIG. 18;

FIG. 22 is a view of an in-dash display system of the vehicle which is used for displaying images from one or more selected ones of the cameras;

FIG. 23 is a perspective view of a side rail being secured to a vehicle roof using an electromechanical fastener in accordance with one embodiment of the present disclosure;

FIG. 24 is a cutaway perspective view of a portion of the side rail and the electromechanical fastener shown in FIG. 23, which facilitates both a mechanical coupling of the side rail to the vehicle roof, as well as an electrical connection through a body of the electromechanical fastener itself;

FIG. 25 is a high level, partial side cross-sectional view of one embodiment of a fastener in accordance with the present disclosure;

FIG. 26 is an exploded perspective view of the fastener of FIG. 25; and

FIG. 27 is a perspective view of a portion of a support rail incorporating a metallic tab element of the fastener.

Corresponding reference numerals indicate corresponding parts throughout the several views of the drawings.

### DETAILED DESCRIPTION

The following description is merely exemplary in nature and is not intended to limit the present disclosure, application, or uses.

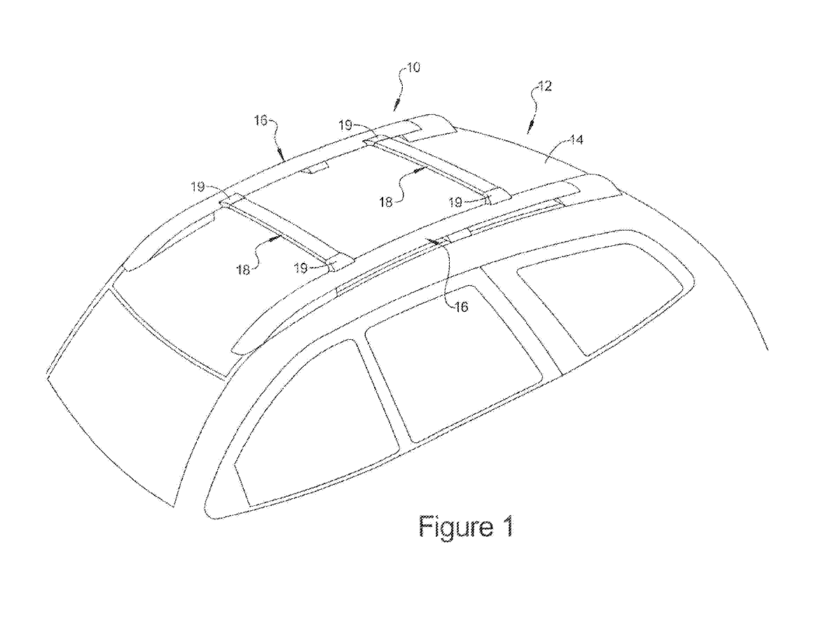

Referring to FIG. 1 a motor vehicle 12 is shown in which one embodiment of a vehicle article carrier system 10 in accordance with the present disclosure is secured to the motor vehicle 12. The vehicle article carrier system 10 is secured to an outer body surface 14 of the motor vehicle 12 and includes a pair of support rail assemblies 16 secured parallel to one another to extend along a major longitudinal axis of the motor vehicle 12. A pair of cross bars 18 is supported by the support rail assemblies 16 such that the cross bars 18 extend perpendicularly across between the support rail assemblies 16. Each of the cross bars 18 may incorporate an end support 19 at both ends thereof that may be secured to the support rail assemblies 16. While two cross bars 18 are shown, it will be appreciated that a greater or lesser number of cross bars may be employed. One or both of the cross bars 18 may be adjustably positionable on the support rail assemblies 16 to better configure them to support variously sized articles thereon above the outer body surface 14. The vehicle article carrier system 10 may be used on sedans, wagons, cross overs, sport utility vehicles, and possibly even over the bed of a pickup truck with possibly only minor modifications. Accordingly, the vehicle article carrier system 10 is not limited to use with only one specific type of vehicle.

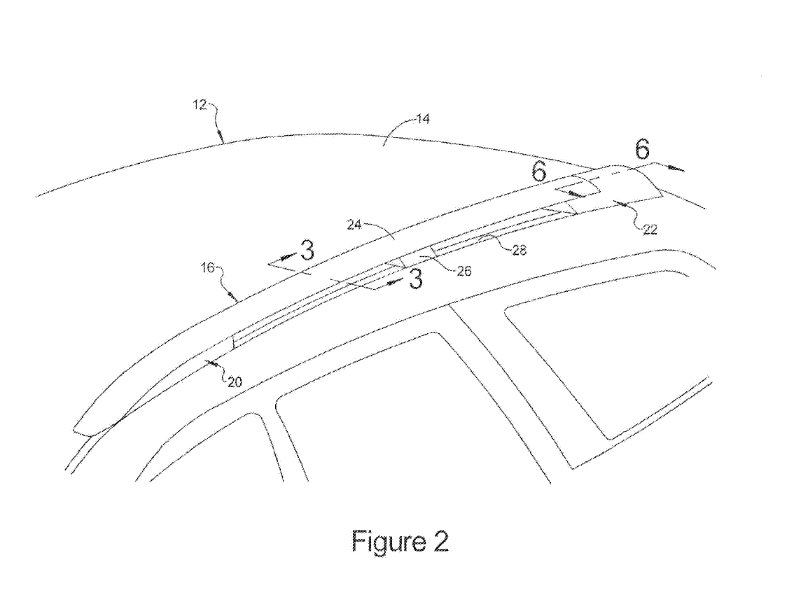

Referring to FIG. 2 an enlarged illustration of one of the support rail assemblies 16 is provided. In this example both of the support rail assemblies 16 are of identical construction, so the following description of the construction of one of the support rail assemblies 16 shown in FIG. 2 will apply equally to the construction of the other one of the support rail assemblies 16. The support rail assembly 16 includes a front support foot 20, a rear support foot 22 and a support rail 24 that extends between the front support foot 20 and the rear support foot 22. An optional center support foot 26 is provided in this implementation. A decorative molding 28 is shown positioned in the ditch channel of the outer body surface 14.

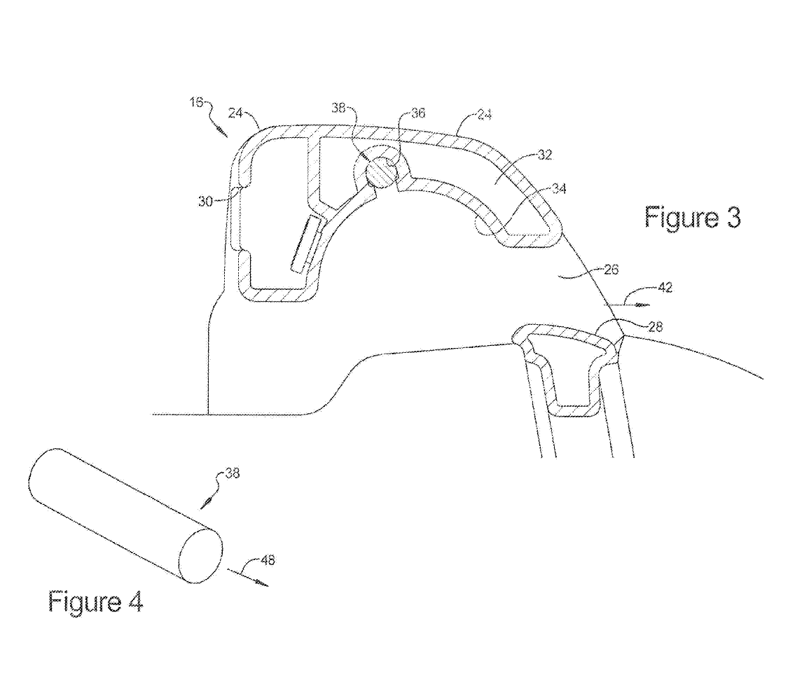

Referring to FIG. 3, the cross-sectional construction of the support rail 24 is shown. The support rail 24 has a longitudinally extending, sideways opening channel 30 that extends along the support rail 24. The end supports 19 at one end of each of the cross bars 18 may be secured to the channel 30 via any suitable clamping-like structure. Suitable end supports and cross bars are disclosed in U.S. Pat. Nos. 7,198,184 and 6,779,696, as well as U.S. Patent Publication 2007/0151188 owned by JAC Products, Inc., and the disclosure of each of these documents is hereby incorporated by reference into the present disclosure.

The support rail 24 may also include a hollow section 32 and a lower surface that forms a semi-circular shaped undersurface portion 34. A channel 36 may be formed to extend longitudinally along at least a major portion of a length of the support rail 24 in which a light transmitting element 38 is disposed. The light transmitting element 38 may thus extend parallel to a longitudinal axis of the support rail 24 and along a major portion of the longitudinal length of the support rail 24. The light transmitting element 38 may be formed by virtually any type of fiber optic type cable or light transmitting component. Preferably the light transmitting element 38 is at least somewhat flexible. One component that is especially well suited for use as the light transmitting element 38 is a commercially available LED light strip. The LED (Light Emitting Diode) light strip is highly energy efficient and can be driven by a low DC voltage. If a conventional fiber optic cable is used, then a light source will be required to feed an optical signal in to one end or the other of the fiber optic cable. In one embodiment the light transmitting element 38 may simply be inserted into the channel 36 during assembly of support rail 24. Alternatively, suitable fastening clips, adhesives or any other suitable structure could be used to help hold the light transmitting element 38 within the channel 36, if needed. The light transmitting element 38 operates to radiate light along its length, with a substantial portion of the light being directed toward the outer body 14 surface of the vehicle 12. The semi-circular shaped undersurface portion 34 and the decorative molding strip 28 may also help to reflect light towards the side of the vehicle 12 in the direction of arrow 42. The percentage of light reflected may be dependent in part on the color of the semi-circular undersurface portion 34, the precise shape of the semi-circular undersurface portion 34, the color of the outer body surface 14, and the color of the decorative molding 28. Optionally, a reflective surface coating may be applied to the semi-circular undersurface portion 34 and/or its shape tailored to reflect the radiated light most efficiently in a desired direction.

A representative portion of the light transmitting element 38 is shown in FIG. 4. The light transmitting element 38 preferably has dimensions selected in accordance with the inner dimensions of the channel 36 so that it may be slid into the channel, yet still provide at least a small degree of frictional fit within the channel 36. As such, the cross sectional shape of the light transmitting element 38 will be selected at least in part based on the cross sectional shape of the walls that form the channel 36, and such that a significant portion of the light transmitting element 38 will be able to radiate optical energy out from the channel 36. In this regard it will be appreciated that the channel 36 may take a variety of cross sectional shapes, and it will be appreciated that the channel 36 as shown in FIG. 3 is but one suitable cross-sectional shape that may be used.

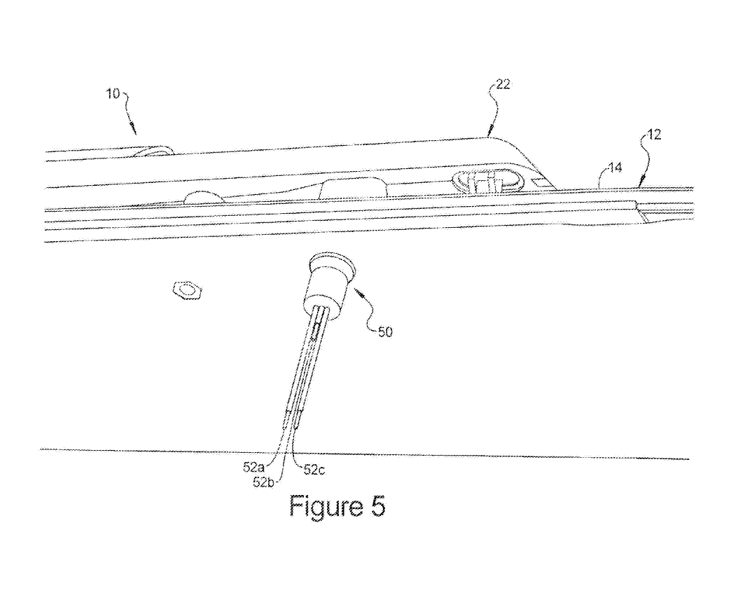

Referring to FIG. 5, the rear support foot 22 of the support rail 16 is shown positioned over an LED housing 50 which houses an LED (not visible in FIG. 5) therein. A plurality of electrical conductors 52a, 52b and 52c extend from the LED housing 50 that may be connected to suitable conductors of a wiring harness of the vehicle 12. The conductors 52a, 52b and 52c may be used to allow control over the operation of the LED in accordance with use of a key FOB of the vehicle, a turn signal of the vehicle, or possibly even the headlights or daytime running lights of the vehicle, or possibly when the vehicle's lights are placed in the emergency flashing condition. Thus, the LED can be controlled to turn on for a controlled time when an operator presses an “UNLOCK” button on the vehicle's key FOB. Alternatively, the LED can be turned on by a suitable electrical signal when the vehicle headlights are turned on, when a brake pedal of the vehicle 12 is depressed, or whenever the daytime running lights of the vehicle are turned on, presuming that the vehicle incorporates daytime running lights. It will be appreciated that the ON/OFF operation of the LED could be controlled in virtually any fashion assuming suitable electrical power and control signals are applied thereto.

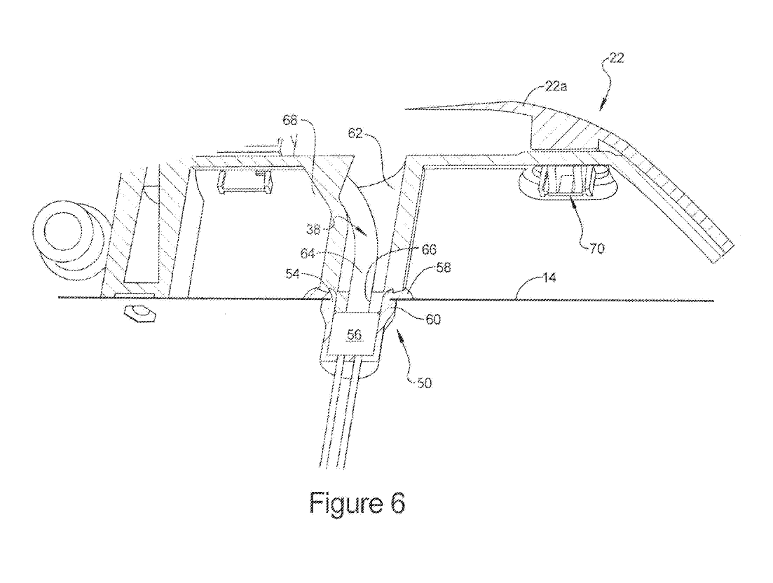

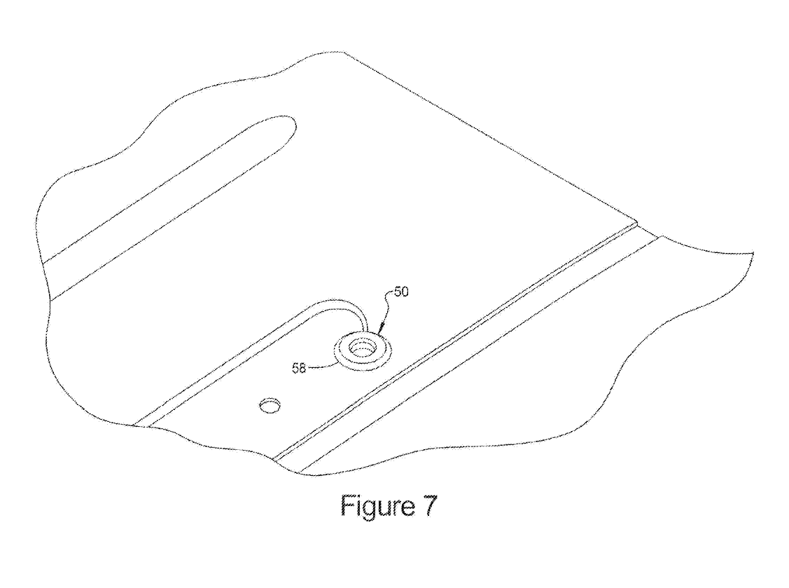

With reference to FIG. 6, the LED housing 50 can be seen in greater detail installed within an opening 54 in the outer body surface 14 of the vehicle 12. The LED housing 50 houses at least one LED 56 therein and may be formed from a relatively stiff rubber or a combination of plastic or metal, with a rubber coating there over. The LED housing 50 may preferably incorporate a flange 58 and a lip 60 that form a narrow circumferential channel therebetween. The LED housing 50 may have a diameter that is selected to be just slightly smaller than the diameter of the opening 54, and may be inserted through the opening 54 from an exterior side of the outer body surface 14. When inserted into the opening 54 in this manner the lip 60 is compressed as it passes through the opening 54, and the LED housing 50 then engages the opening so that the LED housing 50 is captured in the channel between the flange 58 and the lip 60. The LED housing 50 is shown in FIG. 7 without the support rail 16 positioned on the outer body surface 14. It will be appreciated that while a single LED 56 is illustrated in FIG. 6 within the LED housing 50, that two or more LEDs could be housed therein depending on the size of the housing and the size of the opening 54. Alternatively the LED housing 50 may form an enclosure for housing a circuit board with one or more LEDs, where the housing is secured by any suitable means over the opening 54. Thus it will be appreciated that the LED housing 50 may take a wide variety of shapes and sizes as needed to meet the needs of a specific application.

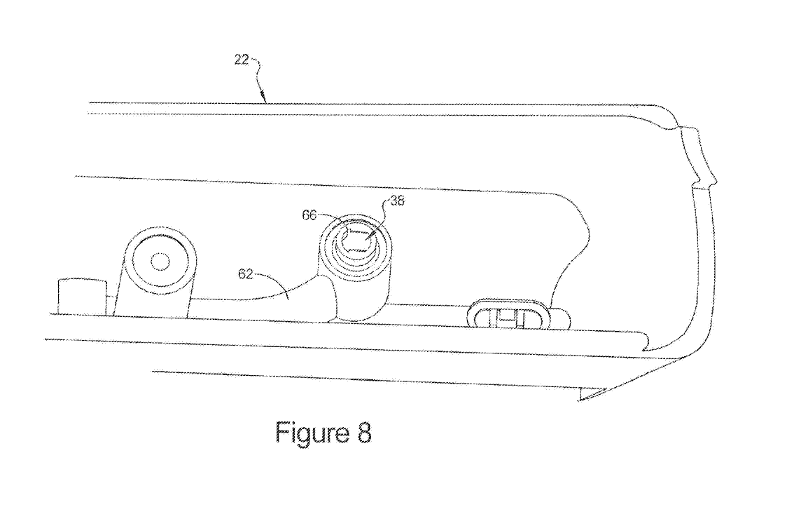

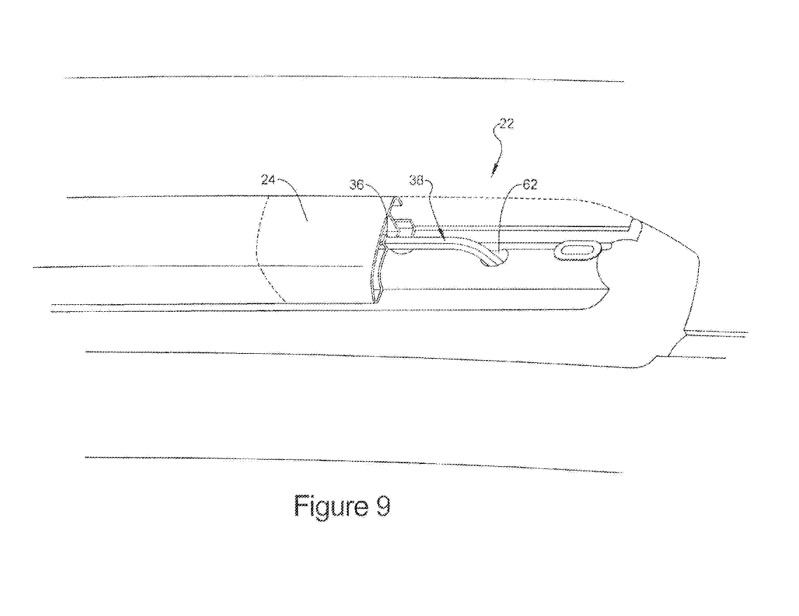

With further reference to FIG. 6, the rear support foot 22 may include an integrally formed, curving channel 62 that holds an input end 64 of the light transmitting element 38 and helps to form a 90 degree bend in the light transmitting element 38 as it extends through the channel 62. In this embodiment it will be appreciated that the light transmitting element 38 is a passive component, for example an optical fiber, that requires an optical input signal be input to one end of the light transmitting element 38, and thus that at least one end of the element 38 be placed in close proximity with a light source. In this example the input end 64 may extend through an opening 66 into abutting contact with the LED 56 or close to abutting contact. It is not critical that the input end 64 of the light transmitting element 38 actually contact the LED 56 or be perfectly concentrically aligned with the LED 56. It is sufficient for the LED 56 to transmit substantially all of its optical energy into the light transmitting element 38 if the input end 64 is merely closely adjacent to the LED 56. It is acceptable if the input end 64 is positioned at least within a few millimeters of contacting the LED 56, and substantially concentrically aligned with the LED 56. The channel 62 preferably includes a curving portion 68 that provides a gradual bend to the light transmitting element 38 to prevent kinking it. FIG. 8 illustrates a face of the input end 64 of the light transmitting element 38 as it appears before the rear support foot 22 is secured to the outer body surface 14. FIG. 9 illustrates the rear support foot 22 and the support rail 24 with a portion of the light transmitting element 38 exposed.

It is a significant benefit of the above-described design and construction of the support rail 16 that no electrical or mechanical connectors are required to interface the input end 64 of the light transmitting element 38 to the LED 56, when the light transmitting element is a passive component like a fiber optic cable. Simply positioning the face of the input end 64 of the light transmitting element 38 against, or closely adjacent to, the LED 56 is sufficient to couple the light from the LED 56 into the light transmitting element 38. This arrangement significantly simplifies the construction of the support rail 16, expedites its attachment to the outer body surface 14 and helps to reduce the overall cost of the system 10. Moreover, since no electrical connector is required, there is no possibility that moisture or corrosion of the contacts of the electrical connector may affect the coupling of the optical signal from the LED 56 into the light transmitting element 38.

The support rail 16 may be assembled by positioning (e.g., press fitting) the light transmitting element 38 within the channel 36 of the support rail 24, and such that a predetermined length of the input end 64 is projecting from an end of the support rail 24 that will pass through the rear support foot 22. The free end (i.e., the input end 64) of the light transmitting element 38 is then positioned in the channel 62 of the rear support foot 22 such that the input end extends into the opening 66 (FIG. 6). The rear support foot 22 and the front support foot 20 may then be secured to the outer body surface 14 of the vehicle 12, and the support rail 24 may then be secured to the support foot portions 22 and 24 by any suitable fasteners (not shown). In one embodiment a decorative cover, such as cover 22a in FIG. 6, may be secured to the rear support foot 22 to cover the channel 62 and the area where the light pipe 38 enters the channel 36 in the support rail 24. Fastening of the decorative cover 22a may be accomplished by the use of suitable cooperating flexible tab structures 70 on the decorative cover 22a and the rear support foot 22, or by any other suitable means of attachment.

It will be appreciated that while the support rail 16 has been described as incorporating a single length of the light transmitting element 38, that two or more separate lengths of the light transmitting element 38 may be incorporated. In such an implementation, a corresponding number of LEDs 56 may be incorporated to provide an independent optical signal to each section of the light transmitting element 38. In some applications this may provide more uniform intensity of illumination along the full length of the component being illuminated.

If the light transmitting element 38 is a DC powered light strip, then it will be appreciated that the LED housing 50 and the LED 56 will not be needed. Instead a suitable connection will need to be made to the light transmitting element to supply the needed DC power to it. The connection may be a physical plug-and-socket connection, or it may be an inductive coupling. If an inductive coupling is used, then magnets may also be used, one being at one end of the light transmitting element and the other being associated with the DC power source, such that when the two magnets are brought into close proximity to one another they will attract and physically engage one another. However, virtually any type of coupling could be used to facilitate the supply of DC power to the light transmitting element 38. As another example, the LED 56 within the housing 50 could be replaced with a simple plug or socket which is seated within the housing 50. The plug or socket may then mate with a corresponding component attached to the end of the light transmitting element 38.

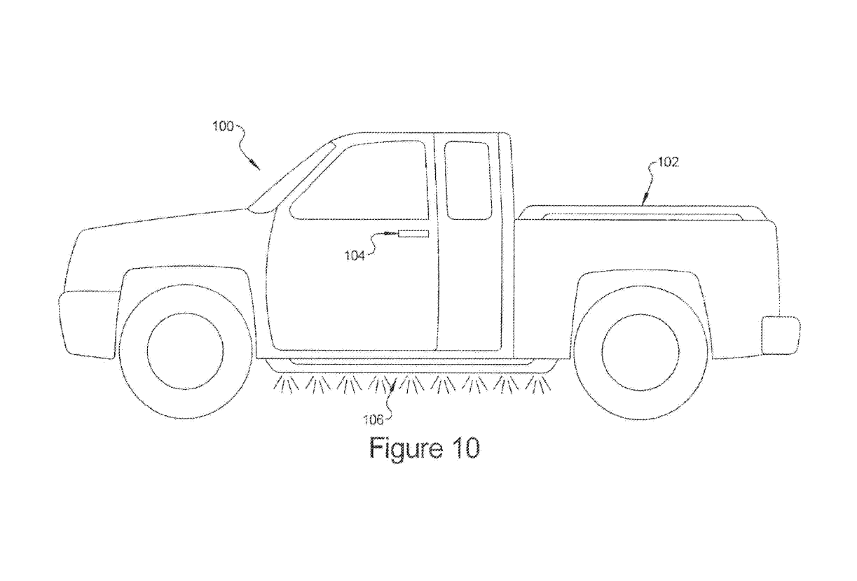

Referring briefly to FIG. 10, a pickup truck 100 is shown that incorporates the teachings of the vehicle article carrier system 10 in connection with a grab rail 102, a door handle molding 104 and a step bar 106. In this example each of the grab rail 102, door handle molding 104 and step bar 106 include one or more light transmitting components, such as light transmitting element 38, held within a channel such that light can be radiated outwardly from the channel to illuminate a limited area of the vehicle 100. It will also be appreciated that the light transmitting element 38 and the teachings related to the construction of the support rail 16 may also be applied to other vehicles such boats, personal watercraft, recreational vehicles, trailers, or any other form of vehicle where it is desired to light a limited portion of the vehicle.

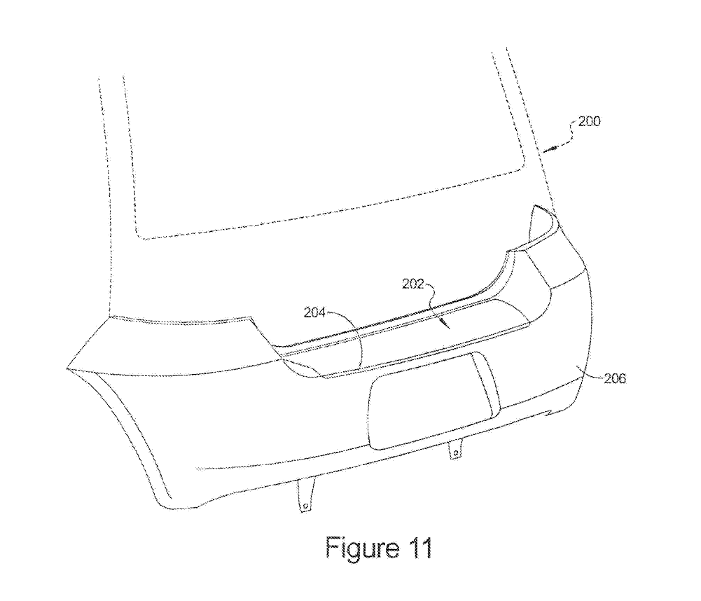

Referring to FIG. 11, a rear step bumper portion 202 of a bumper 206 of a sport utility vehicle 200 may incorporate a light transmitting element 204 therein. The light transmitting element 204 provides a small degree of light that assists in illuminating the rear step bumper portion 202. The light transmitting element 204 may be controlled by a key FOB associated with the vehicle 200 or in concert with the vehicle's headlights, brake lights, daytime running lights, emergency flashers, etc.

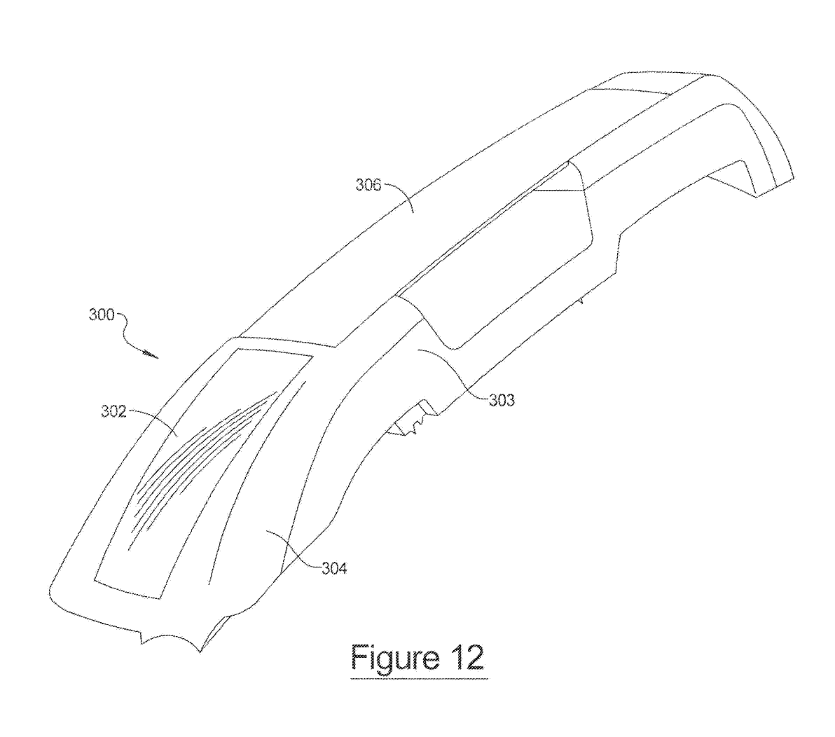

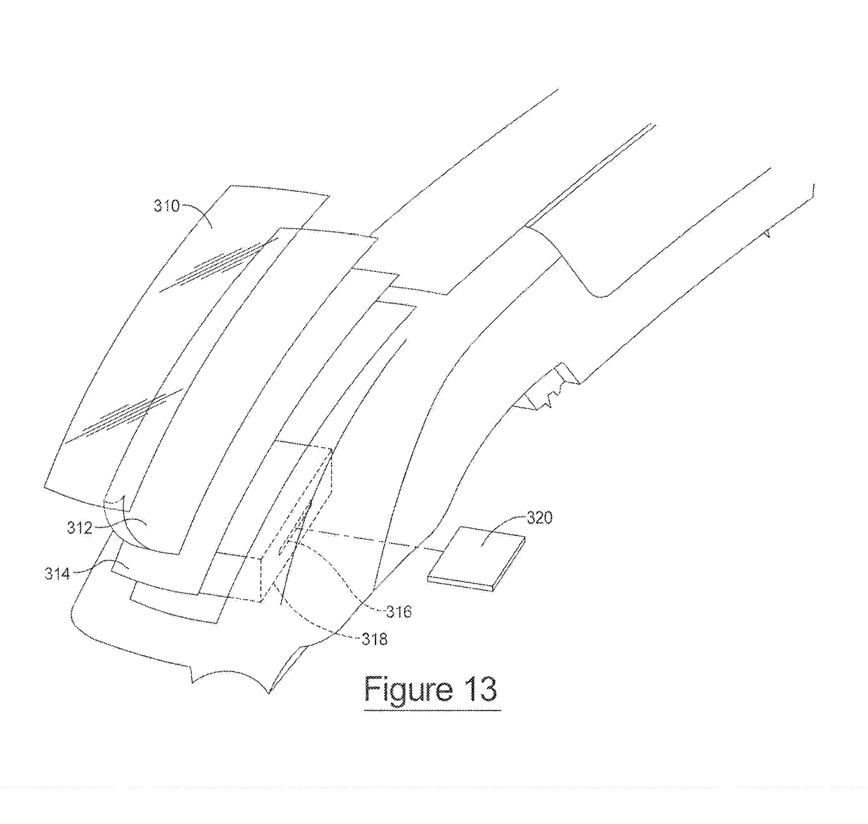

Referring to FIGS. 12 and 13, an embodiment of a support rail 300 is shown that may be used with the vehicle article carrier system 10 of FIG. 1. In this embodiment the support rail 300 includes a solar panel cell 302 that is integrated into at least one of a pair of support feet 304 of the support rail 300. Optionally, a pair of the solar panel cells 302 may be integrated into both of the support feet 304 at the opposing ends of the support rail 300. The support rail 300 may also include a longitudinal portion that spans between the two support feet, and the support feet are adapted to be secured to the outer body surface 14 of the vehicle 12. A cross bar assembly 306 may be supported along an intermediate portion of the support rail 300 in a stowed position so as to not interfere with or cover the solar panel cell 302.

In FIG. 13 the construction of the solar panel cell 302 can be seen in greater detail. It will be appreciated immediately that the solar panel cell 302 could potentially be integrated into other areas of the support rail 300 provided direct exposure to solar radiation still is provided. Moreover, additional solar panel cells 302 could potentially be integrated onto a portion of the cross bar assembly 306 at its outermost ends if needed. However, it is anticipated that providing the solar panel cells 302 at least at two of the support feet 304 will be a highly preferred configuration.

The solar panel cell 302 may include a protective glass cover portion 310, a solar film layer 312 and an aluminum panel 314 for supporting the solar film layer 312. A battery 316 may be placed in electrical communication with the solar film layer 312 via suitable electrical conductors or contacts that make an electrical connection between the solar film layer 312 and the terminals of the battery 316. The battery 316, as well as at least a portion of the solar panel cell 302, is preferably mounted in a recess or pocket 318 of the support foot 304. Preferably the recess or pocket 318 is of sufficient depth and shape such that the solar panel cell 302 is substantially flush with an outer surface of the support foot 304, and appears as an integral, built-in portion of the support foot 304, when the support rail 300 is fully assembled. The battery 316 is also coupled to a light (not shown), such as LED 56 shown in the FIG. 6, that generates optical energy that is focused into one end of a fiber optic light component (not shown), such as light transmitting element 38 in FIG. 6 (e.g., fiber optic cable), to thus provide DC power to power the LED. Optionally, the solar panel cell 302 can be used with the battery 316 to provide DC power to an active lighting component such as an LED light strip as described herein. The solar panel cell 302 is further secured in a manner such that water cannot enter the pocket 318. In one implementation the solar panel cell 302 may be a lightweight, printed CIGS (Copper, Indium, Gallium, and Selenium) solar film available from Nanosolar of San Jose, Calif. However, it will be appreciated that other constructions of solar cells could be used as well. The application of battery power to the light transmitting element 38 (or any other type of light carried on the support rail 300) can be further controlled such that power from the battery 316 is applied when a user presses a “LOCK” or “UNLOCK” button on his/her key FOB. In this embodiment the battery may be coupled to the light transmitting element 38 by some form of switch that is controlled by a signal from a conductor (or conductors) that communicates with the vehicle's electronics.

It will also be appreciated that a conventional photocell could also be implemented in the support rail 300 to further control the power applied to the battery 316 in connection with the sensing of the ambient light level. The photocell would detect when the ambient lighting drops below a predetermined level and automatically switch on battery power to the light transmitting element 38. This could be desirable as a security feature because the photocell would detect when dusk occurs, and would then apply power from the battery 316 to the light transmitting element 38. The light transmitting element 38 would thus be illuminating the vehicle during the night time hours, even when the occupant is not driving the vehicle or present near the vehicle with his/her key FOB. As such, the light pipe 38 would be kept illuminated such as when the vehicle is left unattended in a shopping mall parking lot after dark. This could potentially deter vehicle theft or tampering with the vehicle.

In another implementation the support rail 300 may include a wireless receiver 320 that is also powered by the battery 316 and located in the pocket 318. The wireless receiver 320 could be responsive to a key FOB associated with the vehicle so that the light transmitting element 38 turns on for a predetermined duration whenever the user presses the “LOCK” or “UNLOCK” button on the key FOB. The wireless receiver 320 could also potentially be responsive to a wireless signal from the vehicle's electronics whenever the vehicle's ignition is turned to the “ON” position so that the light transmitting element 38 is illuminated, and powered by the battery 316, whenever the vehicle is running. In this embodiment it will be appreciated that the support rail 300 with its light transmitting element 38, battery 316, solar panel cell 302 and the wireless receiver 320 forms a fully independent and self-contained assembly that does not require any hardwired electrical connections or power from the vehicle's electrical system.

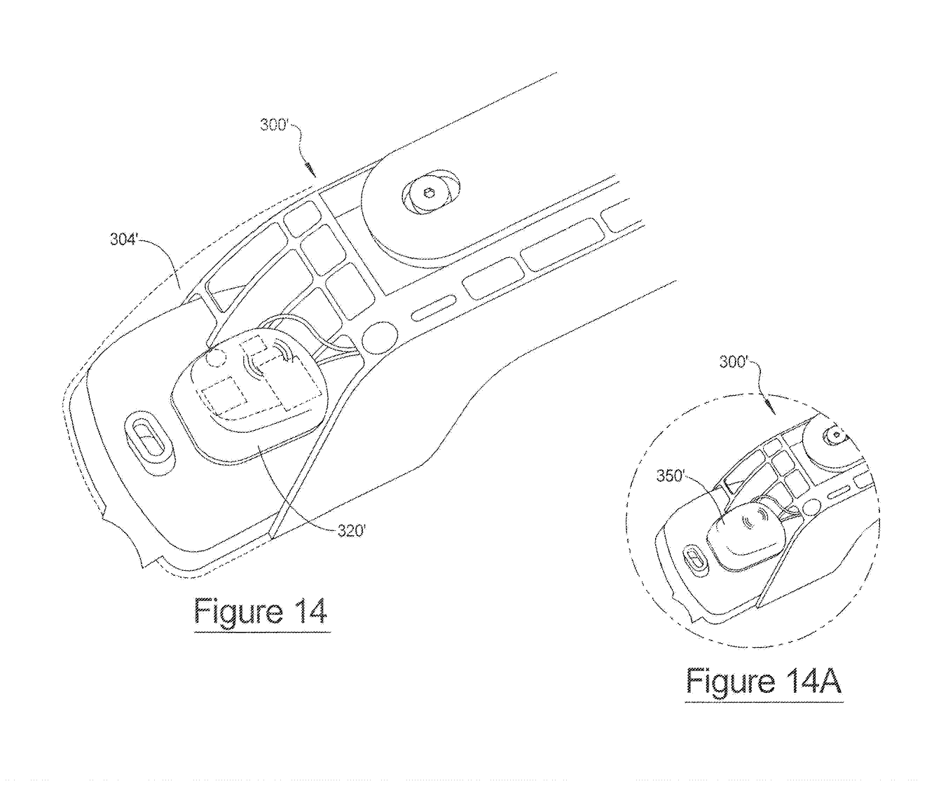

Referring briefly to FIG. 14, another embodiment of the support rail 300′ is shown where an electronic assembly 320′ having its own antenna is mounted in a support foot 304′. The electronic assembly 320′ may be tailored to support satellite radio, GPS, auxiliary phone or radio operations. FIG. 14A illustrates a cover 350′ that may be formed to cover the electronic assembly, and potentially form a hermetically sealed assembly.

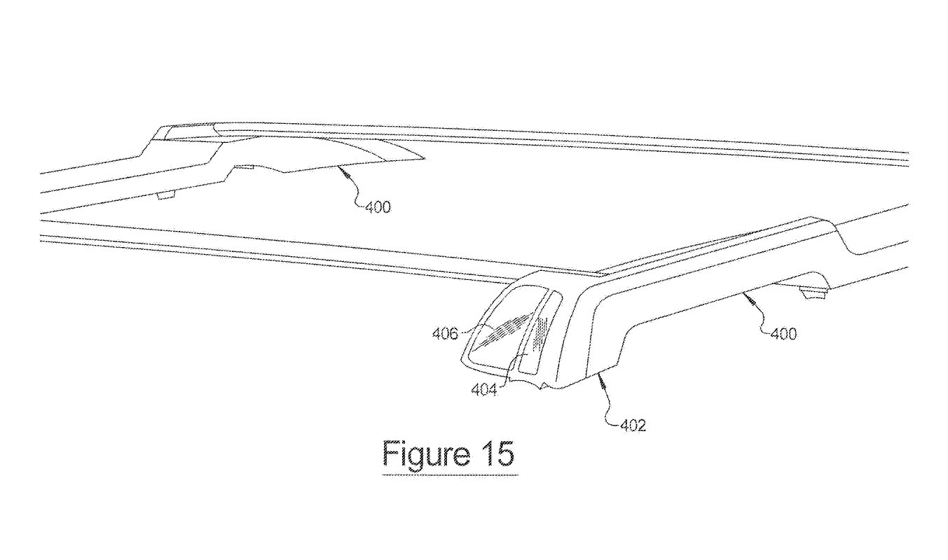

Referring now to FIG. 15, another embodiment of a support rail 400 is shown where the support rail includes a pair of rear facing (relative to the vehicle) support feet 402 that each includes an integrated light 404 and a reflector 406. While only one support foot 402 is shown, it will be appreciated that both rear facing support feet 402 may include the integrated light 404 and the reflector 406. Optionally, the reflector 406 could instead be a light that is responsive to the application of the brake pedal of the vehicle. Such would obviously require wired or wireless communication between the vehicle's brake system components (and/or possibly the vehicle's onboard computer) and the light.

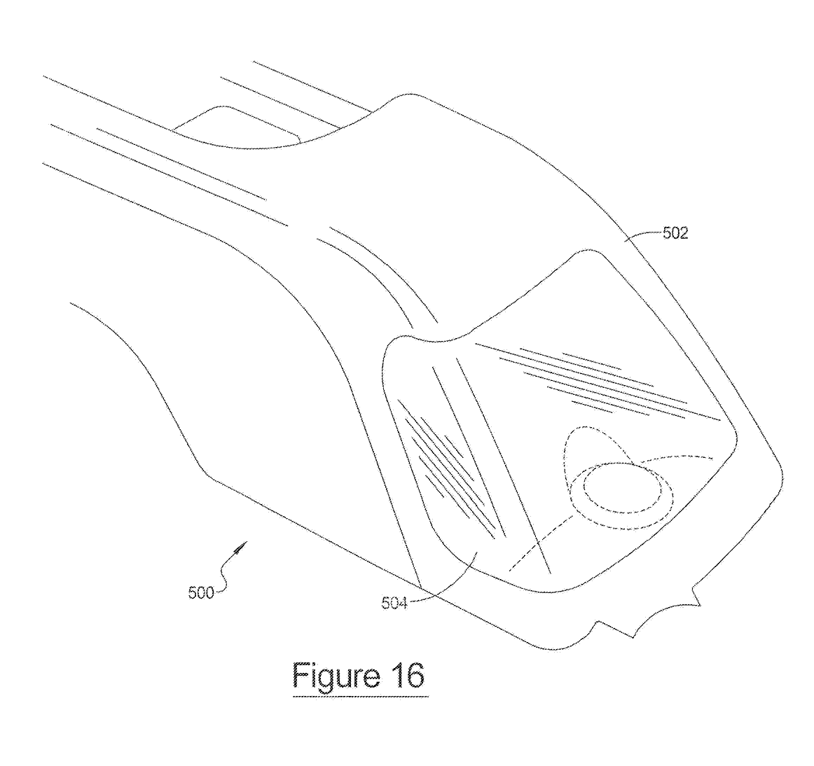

Referring now to FIG. 16, an embodiment of a support rail 500 is shown that has an enlarged, integrated reflector 504 built into its rear support foot 502. The reflector 504 can be included at each one of the support feet 502 of both support rails 500 of a vehicle article carrier.

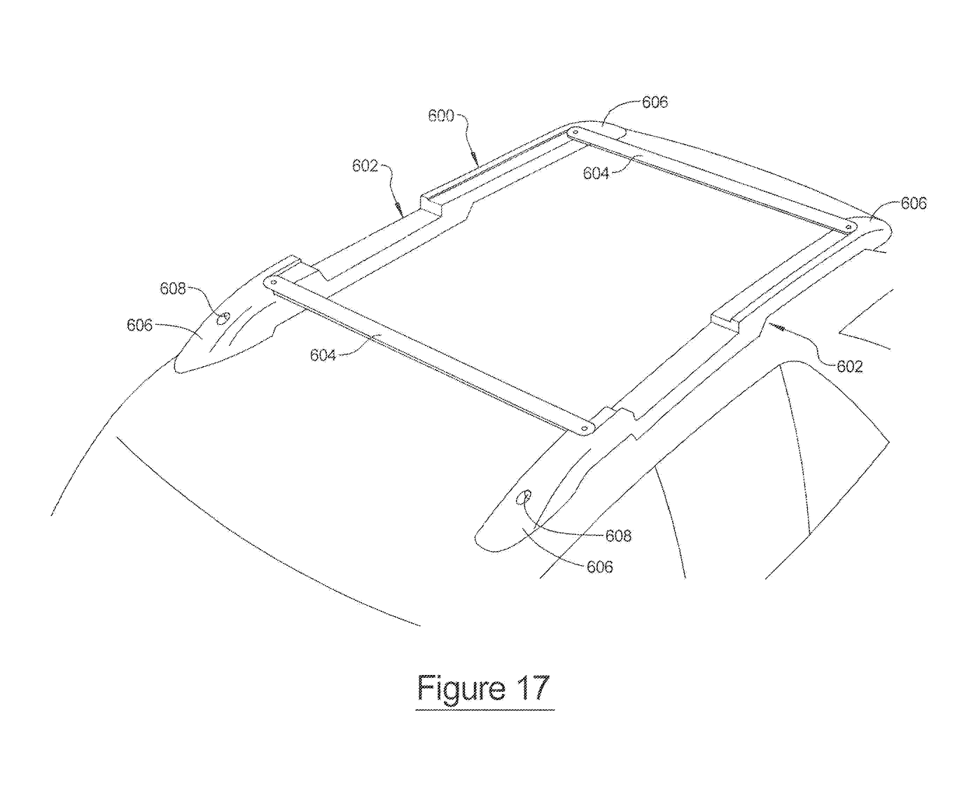

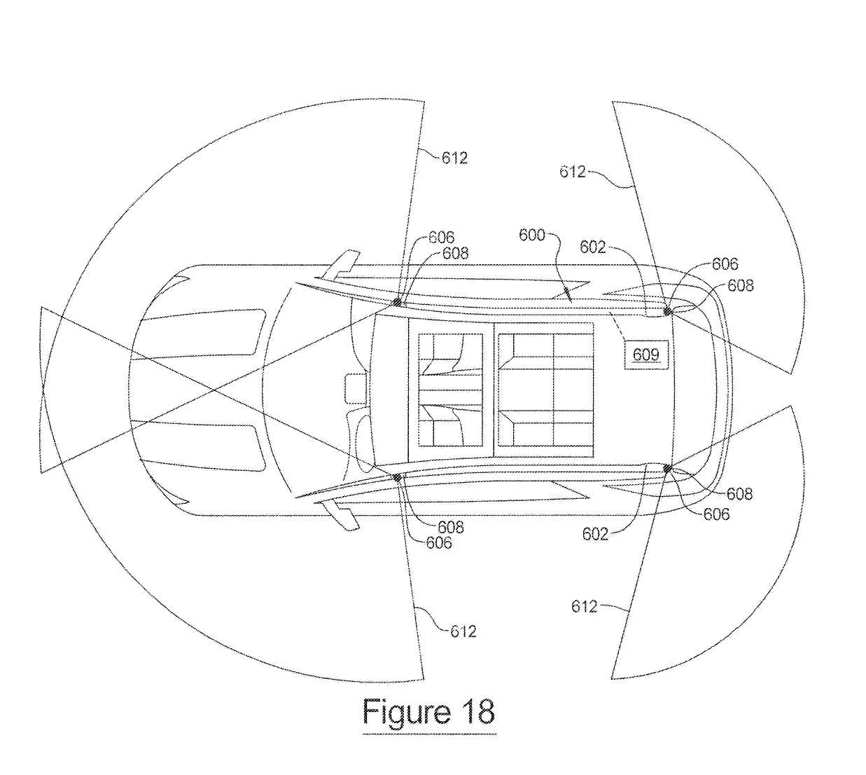

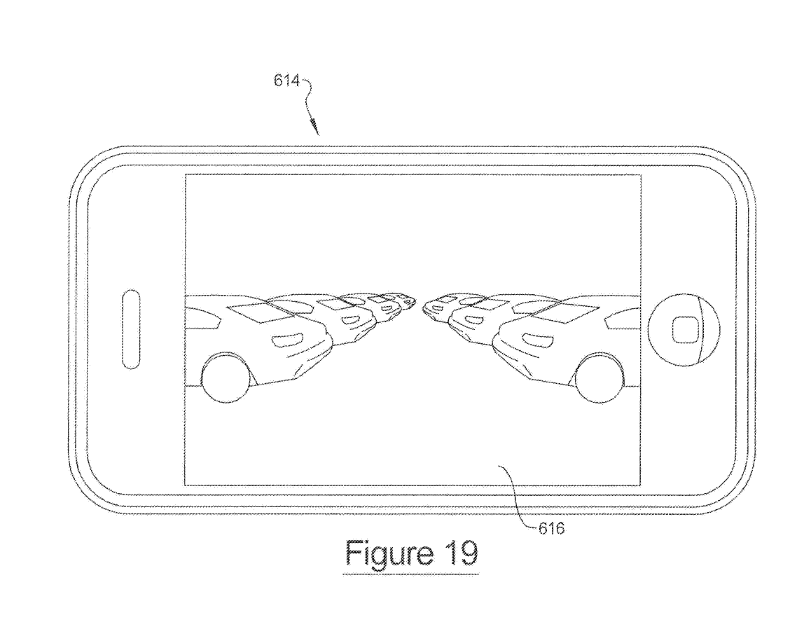

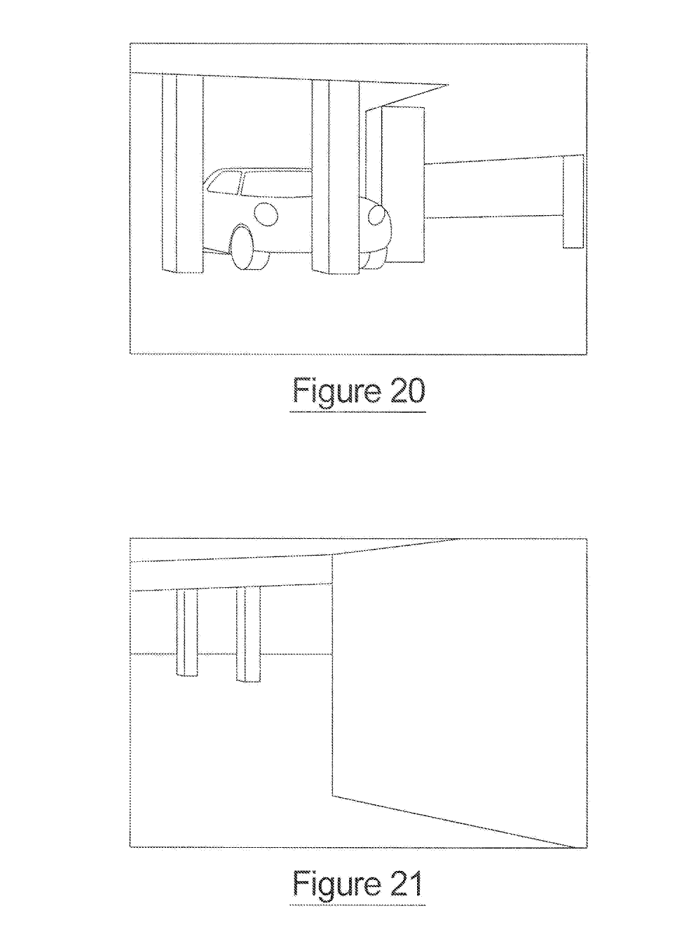

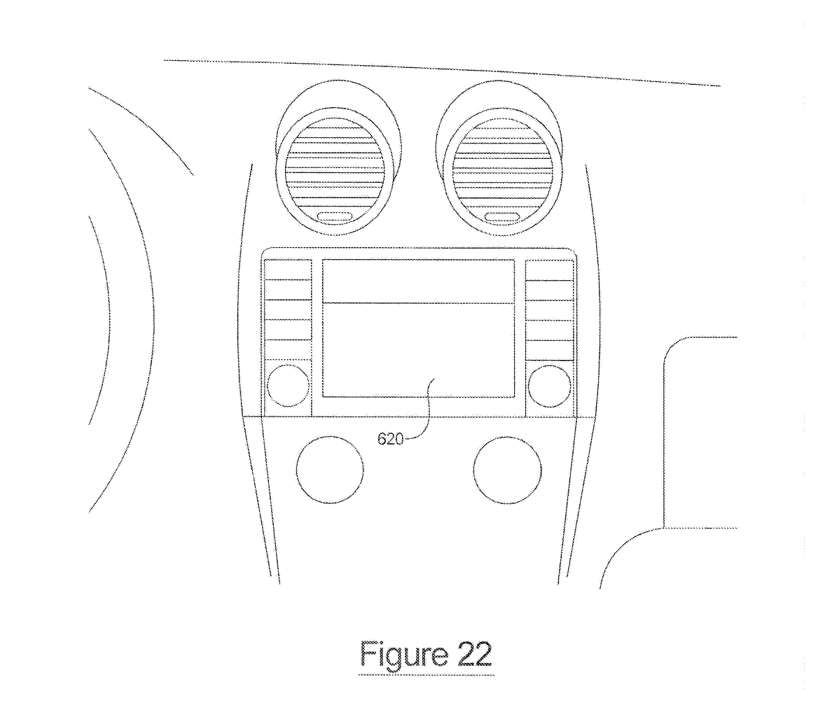

Referring now to FIG. 17, an embodiment of a vehicle article carrier 600 is shown that includes a pair of support rails 602 and a pair of cross bars 604 that are stowable on the support rails 602 when the cross bars are not needed. Each support rail 602 includes a pair of support feet 606 at its opposite ends. Each support foot 606 includes a camera 608 that is able to image a predetermined range or swath of area adjacent to the vehicle. These ranges are indicated by reference numbers 612 in FIG. 18. From FIG. 18 it is apparent that the cameras 608 collectively provide coverage of a significant peripheral area around the vehicle. The cameras 608 may be used to provide images in electronic form to a transceiver 609 that is mounted either in the support rails 602 themselves or within the vehicle. If a transceiver is mounted within the support feet 606 of the support rails 602, such as shown in FIG. 13 with receiver 320, then the transceiver may be powered by its own battery 316. In either event the transceiver 609 may transmit wireless images from each of the cameras to a user's cell phone (e.g., smartphone), as indicated by cell phone 614 shown in FIG. 19. A suitable application may be loaded into and stored on the user's cell phone 614 that allows the user to simply tap the screen 616, or to tap different arrows (not shown) presented on the screen, to toggle from one camera to another, and thus to view the image provided by each one of the cameras 608, as indicated for example at FIGS. 20 and 21. In this manner the user is able to quickly visualize virtually an entire peripheral area surrounding his/her vehicle as the user is approaching the vehicle, but still well before the user reaches and is standing close to the vehicle. It is also possible that the BLUETOOTH® wireless communications protocol could be used such that the user's cell phone receives a wireless signal from the vehicle's electronics and automatically begins running the camera application described above as soon as the user comes within a predetermined proximity of the vehicle (e.g., 30 feet) with his/her cell phone. It will be appreciated that the presentation of the video images provided by the cameras on the user's cell phone provides a significant security benefit to the user. An even further degree of security is provided if the cameras 608 are integrated in the support rails with a light transmitting element or other form of light component that automatically turns on either when the presence of the user's cell phone is sensed or when the user presses a button on his/her key FOB. With brief reference to FIG. 22, the images provided by the cameras 608 may also be fed to an in-dash display system 620 of the vehicle while the vehicle is moving so that the driver can be continuously comprised of the positions of other vehicles behind or adjacent his/her vehicle. This may significantly reduce and/or eliminate “blind spots” associated with the vehicle.

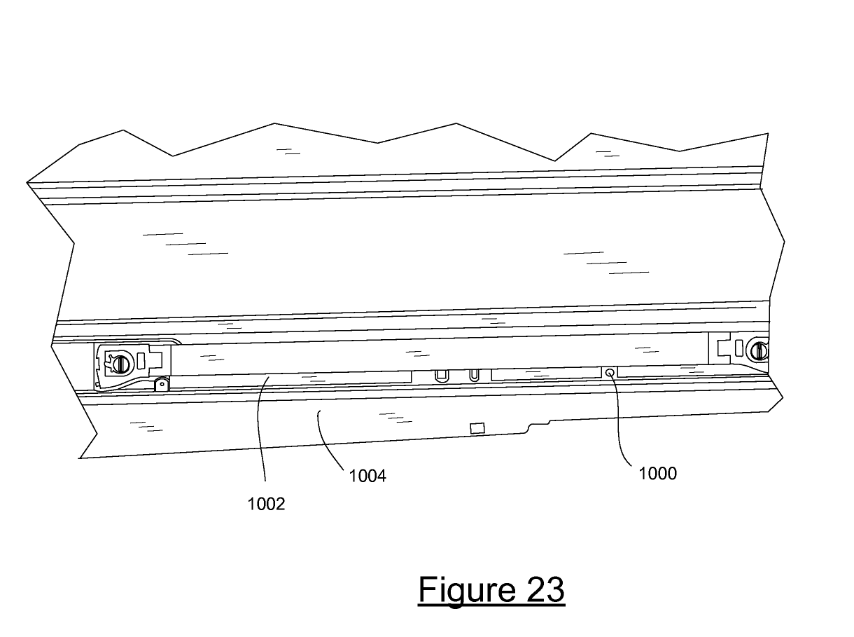

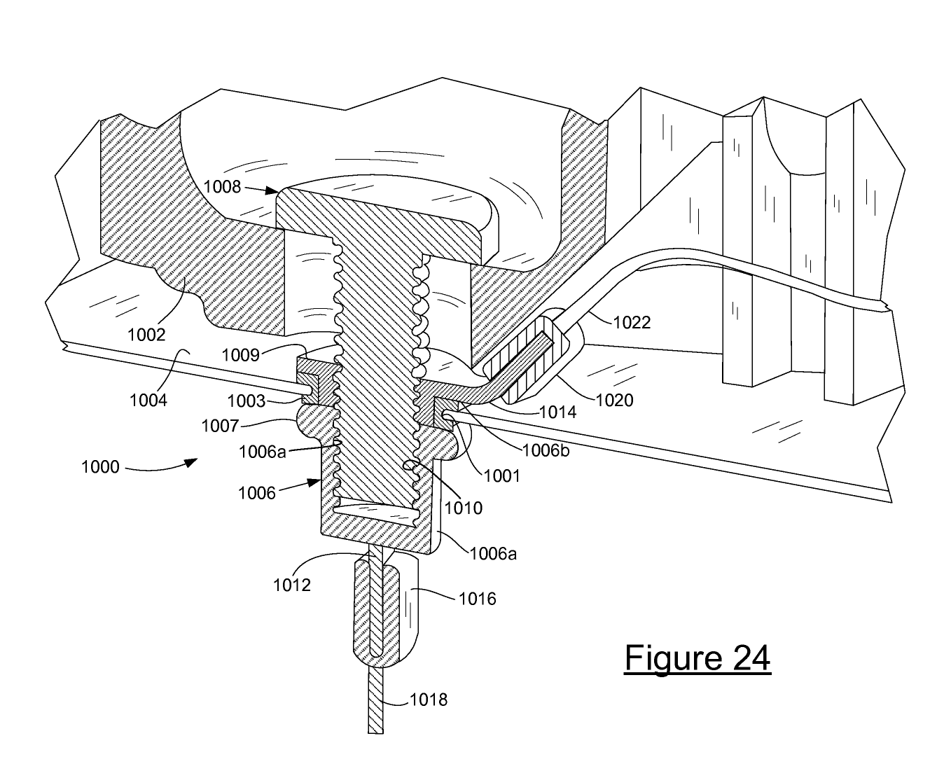

Referring to FIGS. 23 and 24, an electromechanical fastener 1000 is shown in accordance with one embodiment of the present disclosure. The electromechanical fastener 1000 (hereinafter simply “fastener 1000”) may be used to secure a side rail 1002 to an outer body surface 1004 of a vehicle, while also providing a means to supply electrical power to a light disposed on the side rail 1002. The outer body surface 1004 may be a roof, a trunk lid, a liftgate or a tailgate, having an opening or hole 1001 therein. As such, the fastener 1000 may be used to secure not just side rails, but a wide variety of vehicle components to the exterior of the vehicle. The ability to supply electrical power to an electrical component such as a light located on the outside of the vehicle, without requiring a separate hole in the roof or other part of the vehicle through which a suitable conductor is routed, is a significant benefit. It is expected that the fastener 1000 will find utility in not just automotive applications, but in other applications such as with marine vehicles (e.g., boats and other watercraft), with recreational land vehicles (e.g., ATVs, snow mobiles, etc.), in aircraft and aviation applications, and virtually any other application where a need exists to supply electrical power to an electrically powered component located on the outside of a structure or vehicle, and where one needs to minimize the number of holes in a roof, body or wall structure, while fixedly attaching a component to the outer body surface.

With further reference to FIG. 24, the fastener 1000 can be seen to include a body portion 1006 and a threaded bolt 1008 dimensioned to engage in threads 1010 of a blind hole threaded bore 1006a of the body portion 1006. The body portion 1006 may be made from a conductive material, for example steel, and may be constructed to be secured to the outer body surface from one side like a conventional rivet with a suitable external tool, in much like the same manner as a RIVNUT® fastener. During attachment to a wall-like structure, for example outer body surface 104, via the external tool, the deformable portion 1007 of the body portion 1006 becomes slightly deformed, much like a conventional rivet, such that deformable portion forms a material “bulge” projecting slightly outwardly, as shown in FIG. 24. The bulge, along with a flange 1009, cooperate to clamp the body portion within the opening 1001 in the outer body surface 1004. A resilient, non-electrically conductive grommet 1003 may also be inserted into the hole 1001 before installing the body portion 1006 in the hole 1001.

The body portion 1006 also includes a first tab 1012 at a first end 1006a thereof, and a second tab 1014 at a second end 1006b thereof. In this example the tabs 1012 and 1014 are integrally formed with the body portion 1006 but they need not be. If the tabs 1012 and 1014 are separate elements attached to the body portion 1006 via some form of fastener (i.e., screw or rivet), then the tabs would need to be made from an electrically conductive material. Second tab 1014 may be angled so that it extends non-perpendicular from the body portion 1006, while first tab 1012 may project generally coaxially along a longitudinal axis of the body portion 106. Of course, the tabs 1012 and 1014 could be formed to extend at any suitable angle to meet the needs of a specific application.

The first tab 1012 may be secured to an electrical connector 1016 which is electrically coupled to an electrical conductor 1018. The electrical conductor 1018 may be used to pass electric current to the first tab 1012. The body portion 1006 of the fastener 1000 may be used to pass the electrical current through the fastener and to the second tab 1014. An electrical connector 1020 coupled to the second tab 1014 passes the electric current to an electrical conductor 1022. The conductor 1022 transmits the electric current to the light located on the side rail 1002.

The fastener 1000 thus performs the dual function of physically securing the side rail 1002 to the outer body surface 1004, as well as acting as a means to transmit electrical power from a power source located inside the vehicle, through the roof and to an electrically powered component located on an exterior of the vehicle (i.e., in this example on the side rail 1002). This provides a significant benefit in that an additional hole does not need to be formed in the outer body surface 1004 simply to route an electrical conductor through. Eliminating the need for such a separate hole reduces the possibility of water leaking into the interior of the vehicle and also can speed assembly of the side rail 1002 to the vehicle. Another significant advantage is that the fastener 1000, which may form a RIVNUT® style fastener, can be installed in exactly the same way that a standard RIVNUT® fastener is installed on the vehicle. Thus, no change in assembly procedure is needed beyond simply hooking the conductors 1018 and 1022 to their respective tabs 1012 and 1022 once the body portion 1006 is attached to the outer body surface 1004.

It will also be appreciated that while the fastener 1000 is used to supply electrical power to a light on a side rail in this example, that the fastener 1000 could just as readily be used to supply electrical control signals to a device mounted on the exterior of the vehicle. For example, a camera mounted on the side rail 1002 that has the capability of being panned in a horizontal field of view via a small motor could be controlled by suitable electrical control signals originating at the vehicle's computer system. Another example would be having two cameras mounted on the side rail 1002 which are aimed towards the blind spots of the vehicle. Suitable electrical control signals could be used to activate one camera or the other in order to display a real time image obtained by the camera on a dashboard display system of the vehicle. Still further, the fastener 1000 could be used to supply electrical power that is generated from a solar cell mounted on the side rail 1002 or other exterior portion of the vehicle, which is used to help provide power to the vehicle to operate vehicle accessories. Accordingly, one will appreciate that the fastener 1000 may be used in an extremely wide range of applications for providing simultaneously mechanical attachment and transmission of electrical power or electrical control signals through the fastener.

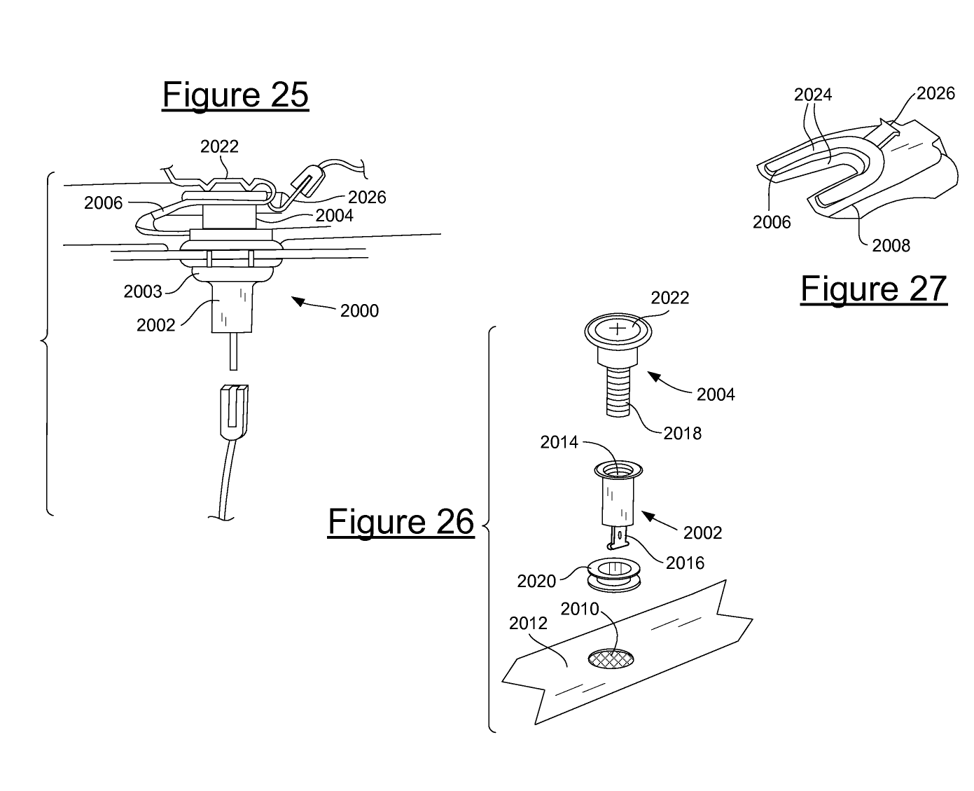

Referring to FIGS. 25-27 an electromechanical fastener 2000 is shown in accordance with another embodiment of the present disclosure. The fastener 2000 in this example is somewhat similar to the fastener 1000 and includes a metallic body portion 2002 and a metallic threaded bolt forming a threaded shoulder bolt 2004. However, with the fastener 2000, an independent metallic tab element 2006 is provided which may be secured, for example by insert molding or adhesives, to a portion of plastic support rail 2008. The location on the support rail 2008 at which the tab element 206 is secured will be adjacent to an opening 2010 in a vehicle outer body roof structure 2012 when the support rail 2008 is positioned on the roof structure and about to be fixedly attached to the roof structure.

In FIG. 26 the body portion 2002 may have a threaded blind hole 2014 and a tab 2016. The tab 2016 enables a conventional electrical connector to be attached to the body portion 2002. A conductor (not shown), for example a wire, may be associated with the electrical connector. The conductor may supply electrical current to the fastener body portion 2002.

The body portion 2002 may include a deformable portion 2003 that is configured to bulge outwardly when the body portion 2002 is secured in a rivet-like fashion within an opening in a wall-like structure, for example within a hole in the outer body surface of a vehicle roof structure.

The shoulder bolt 2004 may have a threaded portion 2018 that engages within the threaded blind hole 2014 of the body portion 2002, and thus makes an electrical connection to the body portion 2002. In this manner electrical current may be transmitted through the body portion 2002 and the shoulder bolt 2004. A resilient insulating grommet 2020 made from rubber or any other suitable electrically insulating and resilient material, may be positioned in the opening 2010 before the body portion 2002 is inserted through the opening. In this manner the vehicle's outer body roof structure 2012 is electrically insulated from the body portion 2002 of the fastener 2000. The grommet 2020 further helps to ensure against any water or moisture entering through the opening 2010.

The shoulder bolt 2004 may also include an enlarged flange or head portion 2022 which is able to physically grip the tab element 2006 when the fastener 2000 is being used to secure the support rail 2008 to the outer body surface 2012 of the vehicle. For this purpose the tab element 2006 may include a metallic U-shaped portion 2024 (FIG. 27) from which a metallic tab 2026 extends. The tab element 2006 may be formed as a single piece component from electrically conductive material, for example copper or stainless steel, or alternatively it may be formed as two components that are fastened securely together in any suitable manner. Since both the U-shaped portion 2024 and the tab 2026 are both constructed from electrically conductive materials, when the enlarged head portion 2022 contacts the U-shaped portion 2024 during assembly, a complete electrical path will be formed between the body portion 2002, the shoulder bolt 2004, the U-shaped portion 2024 and the tab 2026. A separate conductor such as a wire with a suitable electrical connector may be secured to the tab 2026. In this manner current supplied through the fastener 2000 can be channeled to one or more electrically driven elements associated with the support rail 2008. For example, lights, cameras, etc., which are mounted on the support rail 2008, can be supplied with electrical current through the fastener 2000. Alternatively, electrical current from a solar panel element positioned on the support rail 2008, may be channeled through the fastener 2000. Still further, the fastener 2000 may be used to channel low power electrical control signals to one or more components mounted on the support rail such as forward facing and rearward facing cameras. In this manner signals from the vehicle's on-board computer system may be used to control one or more electronic components mounted on the support rail.

Example embodiments have been provided herein so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on, ” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical connector comprising:
a body portion made of an electrically conductive material;
the body portion including a flange and a deformable portion configured to bulge outwardly when the body portion is positioned in an opening in a wall-like structure and non-removably coupled, in a rivet-like manner, to the structure, with the flange and the deformable portion operating to secure the body portion to the wall-like structure;
the body portion having a threaded bore, a first tab extending from a first end of the body portion, and a second tab extending from a second end of the body portion, the first tab, the body portion and the second tab forming an electrically conductive path through the connector;
each of the first and second tabs configured to receive a conductor; and
a threaded bolt configured to be threadably inserted into the threaded bore of the body portion for securing an independent component to the wall-like structure using the electromechanical connector.

2. The electromechanical connector of claim 1, wherein the wall-like structure forms an outer body surface of vehicle.

3. The electromechanical connector of claim 1, wherein the threaded bore forms a blind hole threaded bore.

4. The electromechanical connector of claim 1, wherein the first tab extends outwardly generally coaxially from the body portion.

5. The electromechanical connector of claim 1, wherein the second tab extends outwardly at an angle non-perpendicular to the body portion.

6. The electromechanical connector of claim 1, wherein the first and second tabs are each configured to receive an electrical connector.

7. An electromechanical connector for use with an article carrier component, where the article carrier component is fixedly secured to a vehicle roof, the electromechanical connector comprising:
a body portion made of an electrically conductive material;
the body portion including a flange and a deformable portion configured to bulge outwardly when the body portion is positioned in an opening in a wall-like structure and non-removably coupled, in a rivet-like manner, to the structure, with the flange and the deformable portion operating to secure the body portion to the wall-like structure;
the body portion having a threaded bore, and a first tab extending from a first end of the body portion, the first tab configured to receive an electrical conductor;
an independent metallic tab element adapted to be fixedly secured to the article carrier component, the independent metallic tab element including a second tab projecting therefrom adapted to receive an electrically conductive component;
a threaded bolt configured to be threadably inserted into the threaded bore of the body portion for both securing the article carrier component to the vehicle roof, once the body portion is secured in the rivet-like fashion to the vehicle roof; and electrically coupling the independent metallic tab element to the body portion;
wherein the body portion, the first tab, the independent metallic tab element and the second tab form an electrically conductive path through the body portion when the independent metallic tab element is secured to the body portion.

8. The electromechanical connector of claim 7, wherein the independent metallic tab element includes a metallic U-shaped portion configured to receive a section of the body portion.

9. The electromechanical connector of claim 7, wherein the threaded bolt comprises a shoulder bolt.

10. The electromechanical connector of claim 7, wherein the second tab is adapted to receive an electrical connector thereon.

11. The electromechanical connector of claim 7, wherein the first tab is adapted to receive an electrical connector thereon.

12. The electromechanical connector of claim 7, further comprising a resilient grommet adapted to be inserted into the hole in the opening of the wall-like structure, while permitting the body portion to be inserted therethrough.

13. The electromechanical connector of claim 7, wherein the second tab extends non-perpendicular relative to the body portion when the independent metallic tab element is secured to the body portion.

14. An electromechanical connector configured for use with a roof structure of a vehicle, the electromechanical connector comprising:
a body portion made of an electrically conductive material;
the body portion including a flange and a deformable portion configured to bulge outwardly when the body portion is positioned in an opening in a wall-like structure and non-removably coupled, in a rivet-like manner, to the structure, with the flange and the deformable portion operating to secure the body portion to the wall-like structure;
the body portion having a threaded bore, a first tab extending from a first end of the body portion, and a second tab extending from a second end of the body portion, the second end representing the flange of the body portion, and the second tab forming an integral portion of the flange of the body portion, and the first tab forming an integral portion of the body portion at the first end;
the first tab, the body portion, the flange and the second tab forming an electrically conductive path through the electromechanical connector;
each of the first and second tabs configured to receive a conductor; and
a threaded bolt configured to be threadably inserted into the threaded bore of the body portion for securing an independent component to the wall-like structure using the electromechanical connector.

15. The electromechanical connector of claim 14, wherein the second flange extends non-perpendicular to the body portion.

16. The electromechanical connector of claim 14, wherein the threaded bore comprises a blind hole threaded bore.

17. The electromechanical connector of claim 14, wherein the threaded bolt comprises a threaded shoulder bolt.

18. The electromechanical connector of claim 14, further comprising a resilient, non-electrically conductive grommet, adapted to be placed in the opening in the wall-like structure prior to installing the body portion in the opening.

19. The electromechanical connector of claim 14, wherein the wall-like structure comprises a roof structure of a vehicle.
